(19) United States
(12) Patent Application Publication
(10) Pub. No.: US 2012/0102683 A1
(43) Pub. Date: May 3, 2012

(54) MESSENGER CLAMP

(75) Inventor: Brian Boisclair, Goffstown, NH (US)

(73) Assignee: MARMON UTILITY, LLC, Milford, NH (US)

(21) Appl. No.: 13/345,287

(22) Filed: Jan. 6, 2012

Related U.S. Application Data
(62) Division of application No. 12/508,061, filed on Jul. 23, 2009.
(60) Provisional application No. 61/082,986, filed on Jul. 23, 2008.

(51) Int. Cl. F16B 2/06

(52) U.S. Cl. 24/459; 24/522; 24/526

(57) ABSTRACT

Messenger clamps can be formed from two messenger clamp halves. Messenger clamps and messenger clamp halves can include break away portions, which allow a messenger wire to fall when subjected to high impact forces such as a tree falling on the messenger wire. A messenger clamp half for use in forming a messenger clamp can include an inside face having a first clamping groove and a second clamping groove, and an outside face having at least one fault groove. A break away portion of the messenger clamp half can include one of the clamping grooves, and can further includes at least a portion of the fault groove.

### RELATED APPLICATIONS

This application claims priority to U.S. Provisional Patent Application Ser. No. 61/082,986, filed on Jul. 23, 2008, currently pending.

### BACKGROUND

This disclosure relates to messenger clamps utilized with messenger wires for pole-mounted power distribution cables. More specifically, this disclosure relates to messenger clamps having a break away feature.

Utility wires that are attached to utility poles generally include a power distribution line, which can include several power conducting cables, and a messenger wire. An entire run of a power distribution line encompasses the overall distance over which the power conducting cables are to be installed at one time, with individual spans being the distance from one utility pole to the next.

A messenger wire is generally put in position between spans to provide support to the power distribution line. For example, a messenger wire can be formed from multiple strands, including aluminum-clad steel strands, or a combination of aluminum-clad steel strands and aluminum strands. Messenger wires can include, for example, five, seven, or twelve strands, and can have a total messenger wire diameter from about 0.385 inches to about 0.722 inches. A messenger wire can be lashed to the power distribution line by heavy binding wire. The messenger wire is separated from the power distribution line at the utility poles, where it can be attached directly to the pole, or can be attached to a bracket on the utility pole that utilizes a messenger clamp, to provide vertical support for the power distribution line. Generally, the messenger wire is secured to the top of the clamp, and the conductors of the power distribution line hang below the clamp to which the messenger wire is secured.

### BRIEF SUMMARY

Messenger clamps utilized with messenger wires for pole-mounted power distribution lines are provided, herein, that include a break away feature. The messenger clamps can retain a messenger wire under normal loading conditions, and a portion of the messenger clamp can break away under heavy impact loading, such as a tree or branch falling onto the line, to release the messenger wire and reduce the likelihood of, or avoid, the breakage of the utility pole.

In one aspect, a messenger clamp half for use in forming a messenger clamp is provided that includes an inside face having a first, clamping groove and a second clamping groove, an outside face having at least one fault groove, and at least one break away portion. The break away portion can include the first clamping groove or the second clamping groove, and further includes at least a portion of the fault groove.

In another aspect, a messenger clamp is provided that includes a first messenger clamp half and a second messenger clamp half. The first messenger clamp half includes an inside face having a first clamping groove and a second clamping groove, an outside face having at least one fault groove, and at least one break away portion. The break away portion includes the first clamping groove or the second clamping groove and further includes at least a portion of the fault groove.

In a third aspect, a messenger clamp is provided that includes a first messenger clamp half including a bolt hole and a second messenger clamp half including a bolt hole. The first messenger clamp half further includes an inside face having a first clamping groove and a second clamping groove, an outside face having at least one fault groove that is located below the bolt hole when the messenger clamp is installed, and at least one break away portion. The break away portion includes the first clamping groove or the second clamping groove and further includes at least a portion of the fault groove.

### BRIEF DESCRIPTION OF SEVERAL VIEWS OF THE DRAWINGS

Specific examples have been chosen for purposes of illustration and description, and are shown in the drawings attached hereto, forming a part of the specification.

FIG. 1 illustrates a messenger clamp connected to a tangent bracket on a utility pole, with a messenger wire attached thereto.

FIG. 2 is a back perspective view of one example of a messenger clamp half.

FIG. 3 is an end view of the messenger clamp half of FIG. 2.

FIG. 4 is a back view of the messenger clamp half of FIGS. 2 and 3.

FIG. 5 is an end view of a second example of a messenger clamp half.

FIG. 6 is a back view of the messenger clamp half of FIG. 5.

FIG. 7 is a front perspective view of the messenger clamp half of FIGS. 5 and 6.

### DETAILED DESCRIPTION

This disclosure relates to messenger clamps utilized in spacer cable systems for pole-mounted power distribution lines. More particularly, messenger clamps having at least one break away portion are disclosed herein, which allow a messenger wire to detach from a utility pole under certain conditions.

As illustrated in FIG. 1, a messenger clamp 100 can be attached to a tangent bracket 200 on a utility pole 300. A messenger wire 400 can be retained by the messenger clamp 100, and can thus be connected to the utility pole 300 via the messenger clamp 100 and the tangent bracket 200. Preferably, the messenger wire 400 is attached to the bottom of the messenger clamp 100, and hangs under the bolt 500 which secures the messenger clamp 100 to the tangent bracket 200. This configuration differs from the conventional configuration utilized for a messenger wire, where the cable is attached to the top of the clamp.

A messenger clamp 100 can be formed from two messenger clamp halves, and at least one of the messenger clamp halves can include at least one break away portion. Under normal loading conditions, the messenger clamp can retain a messenger wire in clamping grooves on the messenger clamp halves. The messenger clamp can also retain the messenger wire under higher than normal loading conditions, such as severe weather. However, the messenger clamp 100 can allow the messenger wire 400 to detach from its connection to the utility pole 300 under certain conditions that result in break away forces and cause the break away portion of the messenger clamp half to break away from the messenger clamp 100.

The amount of force determined to be a break away force can vary depending upon the conditions under which it is desired that the break away portion of the messenger clamp 100 will break away. Break away forces can be created by forces such as instantaneous load or shock. In some examples, break away forces can be applied in a downward or horizontal direction at a non-specific angle. Break away forces can include, for example, high impact forces such as a tree or large branch falling onto the messenger wire. With currently utilized messenger clamps, a such high impact force, can be transferred from the messenger wire to the utility pole, which can result in the pole breaking. The time and costs associated with replacing utility poles can be very high, particularly in remote or back-lot construction areas. The currently disclosed messenger clamps can break away at a desired location, thus releasing the messenger wire 400 and preventing the impact forces from being transferred to the utility pole 300.

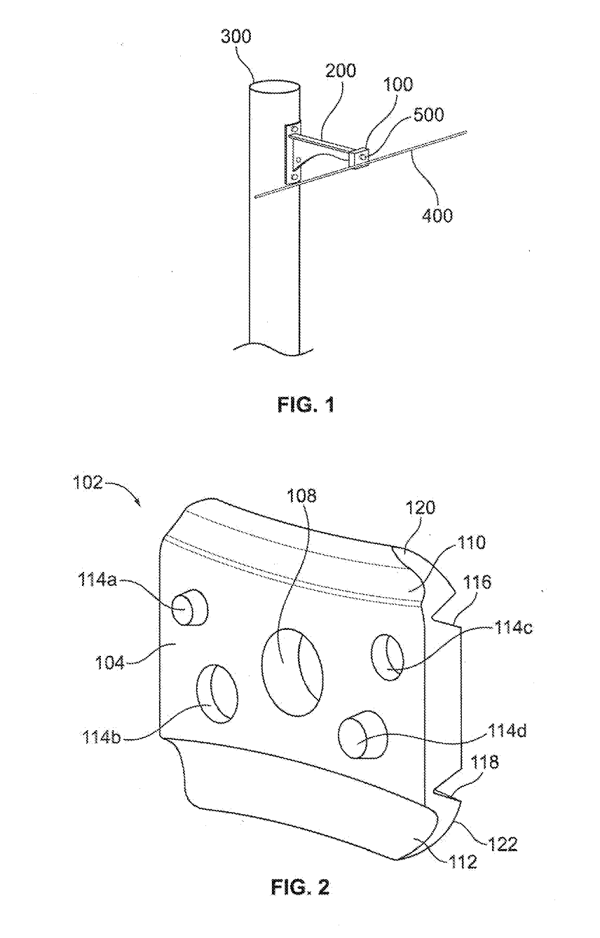

FIGS. 2 through 4 illustrate one example of a messenger clamp half 102. Messenger clamp half 102 has a inside face 104, a outside face 106, and a bolt hole 108. The inside face 104 has a first clamping groove 110, a second clamping groove 112, and one or more mating features 114a-114d. The outside face 106 has a first fault groove 116 and a second fault groove 118. The bolt hole 108 can be located in the center of the messenger clamp half. The bolt hole 108 can be located in the center of the messenger clamp half with respect to the height or width of the messenger clamp half, and is preferably located in the center of the messenger clamp half with respect to the height and width of the messenger clamp half.

Messenger clamp half 102 includes at least one break away portion. A break away portion can be intended to break away when subjected to break away forces. As illustrated in FIGS. 2 though 4, messenger clamp half 102 includes a break away portion associated with each of the first and second clamping grooves 110 and 112. The first breakaway portion 120 of the messenger clamp half 102 includes first clamping groove 110 and at least a portion of the first fault groove 116. Likewise, the second breakaway portion 122 of the messenger clamp half 102 includes second clamping groove 112 and at least a portion of the second fault groove 118.

The fault grooves 116 and 118 can be designed to provide structural failure when subjected to a break away force, allowing their associated break away portions to break away. Thus the amount of the fault groove that is included in a break away portion of the messenger clamp half 102 can vary depending upon the design of the fault groove. For example, the first break away portion 120 can include about half of the first fault groove 116, less than about half of the first fault groove 116, or greater than about half of the first fault groove 116. Similarly, the second break away portion can include about half of the second fault groove 118, less than about half of the second fault groove 118, or greater than about half of the second fault groove 118.

First clamping groove 110 and second, clamping groove 112 can each have a length that traverses the messenger clamp half 102. First clamping groove 110 can be straight or arched along the length of the first clamping groove 110. Similarly, second clamping groove 112 can be straight or arched along the length of the second clamping groove 112. As illustrated in FIGS. 2 and 4, first clamping groove 110 and second clamping groove 112 are each arched along their respective lengths, so that they bow inwardly towards the center of the inside face of the messenger clamp half 102, which is also towards the bolt hole 108 of the messenger clamp half 102.

First clamping groove 110 and a second clamping groove 112 can each have an arcuate cross-section. The cross-section of first clamping groove 110 is preferably a different size from the cross-section of second clamping groove 112, to allow use of the messenger clamp with a broad range of messenger wire sizes. For example, first clamping groove 110 can be smaller than second clamping groove 112, and can have a smaller width and/or radius. In a preferred embodiment, the first clamping groove 110 can be utilized to retain messenger wires having a diameter from about ½ inch to about ¾ inches, and second clamping groove 112 can be utilized to retain messenger wires having a diameter from about 5/16 inches to about 7/16 inches. The messenger clamp can be oriented on a tangent bracket with either first clamping groove 110 or second clamping groove 112 in the lower position, below the bolt hole 108, to receive and retain the messenger wire.

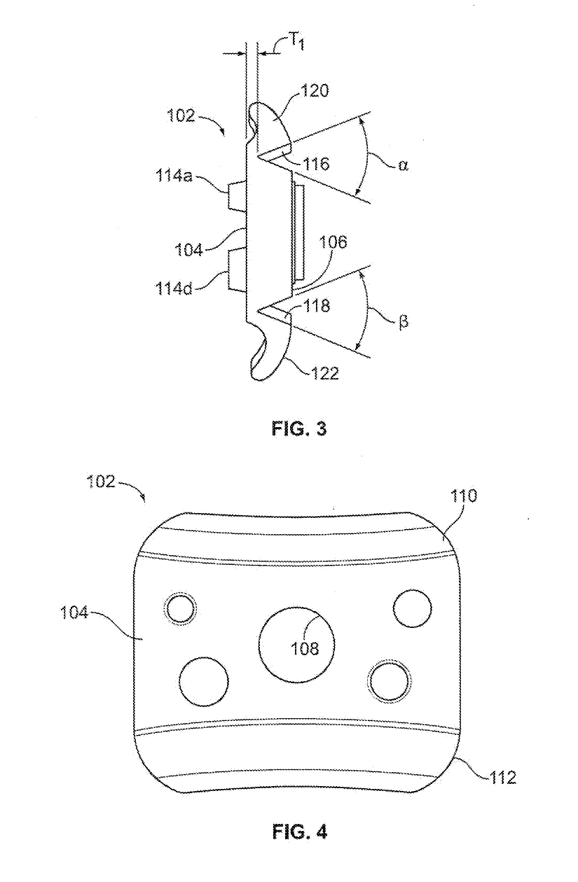

As shown in FIGS. 2 and 3, fault grooves 116 and 118 are located on the outside face 106 of a messenger clamp half 102. The messenger clamp half 102 is designed to break along at least one of the fault grooves, under specified loading parameters, such as when subjected to a break away force. In practice, the messenger clamp half 102 can break along the fault groove associated with the clamping groove that is retaining the messenger wire.

As shown in FIGS. 2 and 3, fault grooves 116 and 118 are grooves that traverse the length of the messenger clamp half 102, and have a V-shaped cross section that is uniform along the length of the messenger clamp half 102. Fault grooves 116 and 118 could have any suitable cross-section shape, and can be formed from notches, grooves, scoring, or any other suitable feature. Additionally, fault grooves 116 and 118 do not have to be uniform along the length of the messenger clamp half 102. Fault grooves 116 and 118 can be intermittent along the length of the messenger clamp half 102.

FIG. 3 illustrates that the V-shaped cross-section of fault groove 116 has an angle α, and the V-shaped cross-section of fault groove 118 has an angle β. The fault grooves 116 and 118 can have any suitable angle. The angles of fault grooves 116 and 118 can be the same or different. In one example, angle α is about 45° and angle β is also about 45°.

Fault grooves 116 and 118 each have a thickness that is less then the total thickness of the messenger clamp half 102 as measured from the outside face 106 to the inside face 104. For illustrative purposes, the thickness T₁ of fault groove 116 is shown in FIG. 3. The thickness of fault groove 118 can be the same as or different than the thickness T₁ of fault groove 116. The thickness of each fault groove can be chosen to provide sufficient structural strength to the messenger clamp to retain a messenger wire under normal loading conditions, as well as under above normal, or high loading conditions that are below the desired break away force, such as severe weather conditions. The thickness of each fault groove can also be selected to provide structural failure when subjected to a break away force.

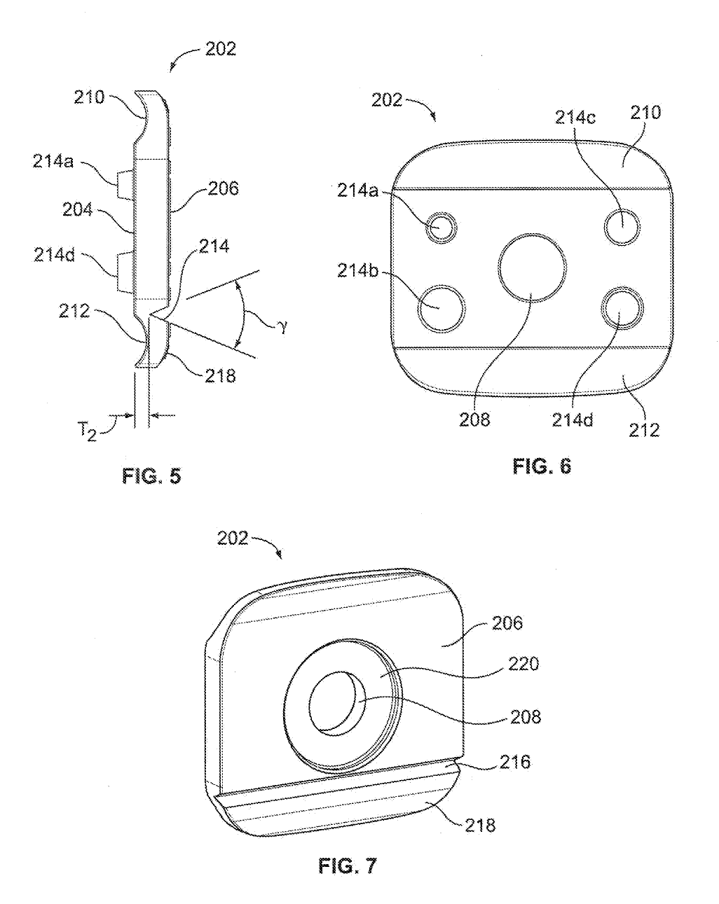

FIGS. 5 through 7 illustrate one example of a messenger clamp half 202. Messenger clamp half 202 has a inside face 204, a outside face 206, and a bolt hole 208. The inside face 204 has a first clamping groove 210, a second clamping groove 212, and mating features 214a-214d. Messenger clamp half 202 includes a break away portion associated with only one of its clamping grooves. The outside face 206 has a fault groove 216, located at or near one end of second clamping groove 212. A breakaway portion 218 of the messenger clamp half 202 includes second clamping groove 212 and at least a portion of the second fault groove 216.

As illustrated in FIG. 7, the messenger clamp half 202 can also include a recessed portion 220. Recessed portion 220 can be located around the bolt hole 208. As illustrated, recessed portion 220 is circular, and is concentric with bolt hole 208. The recessed portion 220 can receive a boss on a tangent bracket, such as tangent bracket 200 illustrated in FIG. 1. The recessed portion 220 can allow the messenger clamp to rotate about the tangent bracket boss, and can thus adjust in position so that it rests at an angle that accommodates any change in elevation between utility poles.

First clamping groove 210 and second clamping groove 212 can each have a length that traverses the messenger clamp half 202. First clamping groove 210 can be straight or arched along its length. Similarly, second clamping groove 212 can be straight or arched along its length. As illustrated in FIGS. 5 and 6, first clamping groove 210 and second clamping groove 212 are each straight.

First clamping groove 2110 and a second clamping groove 212 can each have an arcuate cross-section. As illustrated, the cross-section of first clamping groove 210 can be the same size the cross-section of second clamping groove 212. Alternatively, the cross-section of first clamping groove 210 can be a different size from the cross-section of second clamping groove 212 as discussed above with respect to messenger clamp half 102.

The messenger clamp can be oriented on a tangent bracket with either first clamping groove 210 or second clamping groove 212 in the lower position, below the bolt hole 208, to receive and retain the messenger wire. As shown in FIGS. 2 and 3, fault groove 216 is located on the outside face 206 of a messenger clamp half 202. The messenger clamp half 202 is designed to break along the fault groove 216, under specified loading parameters, such as high impact forces. Thus, in practice, when a messenger clamp is formed utilizing messenger clamp half 202, and is installed with the second clamping groove 212 in the lower position such that a messenger wire is retained in the second clamping groove 212, the messenger clamp half 202 can break along the fault groove 216 and allow the messenger wire to fall when the specific loading parameters are met.

As shown in FIGS. 5 and 7, fault groove 216 is a groove that traverses the length of the messenger clamp half 202, and has a V-shaped cross section that is uniform along the length of the messenger clamp half 202. Fault groove 216 could have any suitable cross-section shape, and can be formed from notches, grooves, scoring, or any other suitable feature. Additionally, fault groove 216 does not have to be uniform along the length of the messenger clamp half 202. Fault groove 116 can be intermittent along the length of the messenger clamp half 202. FIG. 5 illustrates that the V-shaped cross-section of fault groove 116 has an angle γ. The angle γ can be any suitable angle, including, but not limited to about 45°.

Fault groove 216 has a thickness T₂ that is less then the total thickness of the messenger clamp half 202 as measured from the outside face 206 to the inside face 204. The thickness of each fault groove can be chosen to provide sufficient structural strength to the messenger clamp to retain a messenger wire under normal loading conditions, as well as under high loading conditions that are below the desired break away forces, such as severe weather conditions.

A messenger clamp 100 can be formed by mating two messenger clamp halves. The two messenger clamp halves can be the same or different. In one example, two messenger clamp halves 102 as illustrated in FIGS. 2 through 4 can be mated to form a messenger clamp. Mating two messenger clamp halves 102 to form a messenger clamp can be accomplished by bringing together their respective inside faces 104 and mating features 114a-114d. For example, mating features 114a and 114d of a first messenger clamp half 102 would mate with mating features 114b and 114c of a second messenger clamp half 102. In another example, two messenger clamp halves 202 as illustrated in FIGS. 5 through 7 can be mated to form a messenger clamp. Mating two messenger clamp halves 202 to form a messenger clamp can be accomplished by bringing together their respective inside faces 204 and mating features 214a-214d. For example, mating features 214a and 214d of a first messenger clamp half 202 would mate with mating features 214b and 214c of a second messenger clamp half 202. With respect to each example, once the two messenger clamp halves are mated, a bolt can be inserted through the bolt hole 108 or 208 to attach the messenger clamp to a tangent bracket on a utility pole. For example, a ⅝ inch bolt or a ¾ inch bolt, and also preferably a nut or lock washer, can be utilized to attach the messenger clamp to a tangent bracket.

Each half of a messenger clamp can be made of any suitable material, but is preferably cast ductile iron that has a hot dip galvanized finish. For example, when two messenger clamp halves 102 or 202 are combined to form a messenger clamp, each messenger clamp half 102 or 202 can be made of ductile iron that is fabricated from a sand cast mold and each messenger clamp half 102 or 202 can be hot dip galvanized after fabrication.

Messenger clamp halves 102 and 202 can have any suitable dimensions. In a preferred embodiment, messenger clamp halves 102 and 202 can have a length of about 3.5 inches, and a height of about 3 and 3/16 inches. A messenger clamp, formed from two messenger clamp halves, can have any suitable weight, and weight, for example, about 2.2 pounds.

In one example, with reference to FIGS. 1 and 2 through 4, two messenger clamp halves 102 can be mated to form a messenger clamp 100. The messenger clamp 100 can be installed in an orientation where the second clamping grooves of each messenger clamp half are below the bolt hole, and a messenger wire is retained by the second clamping grooves 112 of the first and second messenger clamp halves. Thus, as installed, the messenger clamp can be bolted by bolt 500 to tangent bracket 200 on utility pole 300 such that the two second clamping grooves 112 are in the lower position, below the bolt, and the messenger wire 400 can be received and retained by the two second clamping grooves 112. Under a normal loading conditions, messenger clamp 100 will retain messenger wire 400 on the utility pole 300. If the messenger wire 400 is subjected to a break away force, such as a force that would normally cause utility pole 300 to break, the messenger clamp 100 will break at fault groove 118, causing the second breakaway portion 122 of the messenger clamp, including clamping groove 112 and the messenger wire 400 retained therein, to break off of the messenger clamp 100 and fall.

wherein the messenger clamp is installed in an orientation where the first clamping grooves of each messenger clamp half below the bolt hole,

In another example, with reference to FIGS. 1 and 2 through 4, two messenger clamp halves 102 can be mated to form a messenger clamp 100. The messenger clamp 100 can be installed in an orientation where the first clamping grooves of each messenger clamp half are below the bolt hole, and a messenger wire is retained by the first clamping grooves 110 of the first and second messenger clamp halves. Thus, as installed, the messenger clamp 100 can be bolted to tangent bracket 200 on utility pole 300 such that the two first clamping grooves 110 are in the lower position, below the bolt, and the messenger wire 400 can be received and retained by the two first clamping grooves 110. Under a normal loading conditions, messenger clamp 100 will retain messenger wire 400 on the utility pole 300. If the messenger wire 400 is subjected to high impact loading, such as forces that would normally cause utility pole 300 to break, the messenger clamp 100 will break at fault groove 116, causing the first breakaway portion 120 of the messenger clamp, including clamping groove 110 and the messenger wire 400 retained therein, to break off of the messenger clamp 100 and fall.

In a third example, with reference to FIGS. 1 and 5 through 7, two messenger clamp halves 202 can be mated to form a messenger clamp 100. Messenger clamp 100 can be installed in an orientation where the second clamping grooves of each messenger clamp half are below the bolt hole, and a messenger wire is retained by the second clamping grooves 212 of the first and second messenger clamp halves. Thus, as installed, the messenger clamp 100 can be bolted to tangent bracket 200 on utility pole 300 such that the two second clamping grooves 212 are in the lower position, below the bolt, and the messenger wire 400 can be received and retained by the two second clamping grooves 212. Under a normal loading conditions, messenger clamp 100 will retain messenger wire 400 on the utility pole 300. If the messenger wire 400 is subjected to high impact loading, such as forces that would normally cause utility pole 300 to break, the messenger clamp 100 will break at fault groove 216, causing the first breakaway portion 218 of the messenger clamp, including clamping groove 212 and the messenger wire 400 retained therein, to break off of the messenger clamp 100 and fall.

In a fourth example, with reference to FIGS. 1 and 5 through 7, in areas where it is believed that the break away feature is not needed, or where there is an intention not to allow the messenger wire 400 to detach from the utility pole 300, two messenger clamp halves 202 can be mated to form a messenger clamp 100, which can be bolted to tangent bracket 200 on utility pole 300 such that the two first clamping grooves 210 are in the lower position, below the bolt. A messenger wire 400 can be received and retained by the two first clamping grooves 210. Under a normal loading conditions, messenger clamp 100 will retain messenger wire 400 on the utility pole 300. Because the first clamping grooves 210 do not have a fault groove associated therewith, the messenger clamp is not intended to break and release the messenger wire 400 when the messenger wire 400 is subjected to high impact loading, such as forces that would normally cause utility pole 300 to break.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A messenger clamp half for use in forming a messenger clamp, the messenger clamp half comprising:
an inside face having a first clamping groove and a second clamping groove,
an outside face having at least one fault groove; and
at least one break away portion that includes the first clamping groove or the second clamping groove, and further includes at least a portion of the fault groove.

2. The messenger clamp half of claim 1, wherein the outside face includes a first fault groove and a second fault groove.

3. The messenger clamp half of claim 2, wherein the messenger clamp half includes a first break away portion that includes the first clamping groove and at least a portion of the first fault groove, and a second break away portion that includes the second clamping groove and at least a portion of the second fault groove.

4. The messenger clamp half of claim 1, further comprising a bolt hole.

5. The messenger clamp half of claim 1, wherein the inside face includes one or more mating features adapted to mate with corresponding mating features on a second messenger clamp half.

6. The messenger clamp half of claim 1, wherein the fault groove has a V-shaped cross section.

7. The messenger clamp half of claim 1, wherein the fault groove has an angle of about 45°.

8. The messenger clamp half of claim 1, wherein the first clamping groove and the second clamping groove each have a length that traverses the messenger clamp half, and at least one of the first clamping groove or the second clamping groove is arched along the length and bows inwardly towards the center of the inner face.

9. The messenger clamp half of claim 1, wherein the first clamping groove and the second clamping groove each have a length that traverses the messenger clamp half, and at least one of the first clamping groove or the second clamping groove is straight along the length.

10. The messenger clamp half of claim 1, wherein the first clamping groove and the second clamping groove each have an arcuate cross-section.

11. The messenger clamp half of claim 10, wherein the arcuate cross section of the second clamping groove is a different size than the arcuate cross section of the first clamping groove.

12. The messenger clamp half of claim 1, wherein the fault groove has a thickness that is less than a thickness of the messenger clamp half as measured from the outside face to the inside face, and the thickness is selected to provide sufficient structural strength to maintain a messenger clamp under normal loading conditions.

13. The messenger clamp half of claim 12, wherein the thickness of the fault groove is selected to provide structural failure when the messenger clamp half is subjected to break away forces.

14. A messenger clamp comprising:
a first messenger clamp half; and
a second messenger clamp half;
wherein the first messenger clamp half includes:
an inside face having a first clamping groove and a second clamping groove;
an outside face having at least one fault groove; and
at least one break away portion that includes the first clamping groove or the second clamping groove and further includes at least a portion of the fault groove.

15. The messenger clamp of claim 14, wherein the second messenger clamp half includes:
an inside face having a first clamping groove and a second clamping groove,
an outside face having at least one fault groove; and
at least one break away portion that includes the first clamping groove or the second clamping groove, and further includes at least a portion of the fault groove.

16. The messenger clamp of claim 15, wherein the first and second messenger clamp halves each further comprise a bolt hole.

17. The messenger clamp of claim 16, wherein the messenger clamp is installed in an orientation where the first clamping grooves of each messenger clamp half below the bolt hole, and a messenger wire is retained by the first clamping grooves of the first and second messenger clamp halves.

18. The messenger clamp half of claim 14, wherein the fault groove has a thickness that is less than a thickness of the messenger clamp half as measured from the outside face to the inside face, and the thickness is selected to provide sufficient structural strength to maintain a messenger clamp under normal loading conditions.

19. The messenger clamp half of claim 18, wherein the thickness of the fault groove is selected to provide structural failure when the messenger clamp half is subjected to break away forces.

20. A messenger clamp comprising:
a first messenger clamp half including a bolt hole; and
a second messenger clamp half including a bolt hole;
wherein the first messenger clamp half further includes:
an inside face having a first clamping groove and a second clamping groove;
an outside face having at least one fault groove that is located below the bolt hole when the messenger clamp is installed; and
at least one break away portion that includes the first clamping groove or the second clamping groove and further includes at least a portion of the fault groove.
